(19) United States
(12) Patent Application Publication
(10) Pub. No.: US 2002/0194407 A1
(43) Pub. Date: Dec. 19, 2002

(54) Maintaining fabric device configuration through dynamic reconfiguration

(76) Inventor: Hyon T. Kim, San Jose, CA (US)

Correspondence Address: Robert C. Kowert, Conley, Rose & Tayon, P.C., P.O. Box 398, Austin, TX, 78767, US

(21) Appl. No.: 09/842,531

(22) Filed: Apr. 25, 2001

(51) Int. Cl. G06F 13/00

(52) U.S. Cl. 710/104

(57) ABSTRACT

A fabric-attached device configuration for a host system may be managed in regard to fabric state changes for a host system connected to a fabric. An event may be received indicating a fabric state change for one or more host adapter ports. In response to the event, the host system's fabric device configuration may be dynamically changed. Dynamically changing the host system's fabric device configuration may include bringing online or taking offline one or more fabric devices for the one or more host adapter ports for the host system. In some embodiments, a configuration file may be stored specifying an action to be taken for various types of events. Upon receiving indicating a fabric state change, the configuration file may be accessed to determine the fabric device configuration action to be taken for the type of fabric state change indicated by the event.

### BACKGROUND OF THE INVENTION

1. Field of the Invention

This invention relates to maintaining a host system's configuration of devices attached to a fabric in a storage network.

2. Description of the Related Art

Storage area networks, also referred to as SANs, are dedicated networks that connect one or more systems to storage devices and subsystems. Today, fibre channel is one of the leading technologies for SANs. In general, fibre channel encompasses three networking topologies: point-to-point, loop, and fabric. In a point-to-point topology, a fibre channel host adapter in a system is typically connected to a single fibre channel storage subsystem. In a fibre channel loop network, also called an arbitrated loop, the loop is constructed by connecting nodes together in a single logical ring. Loops can be constructed by connecting nodes through a fibre channel hub in a star-wired topology or by connecting them together in a connected physical loop from node to node. In a fibre channel fabric topology, the storage networks are constructed with network switches. A fabric can be composed of a single switch or multiple switches. Ports on fabric networks connect nodes to switches on low-latency, point-to-point connections.

The nodes connected in the loop and fabric topologies refer to “network nodes” and can be any entity that is able to send or receive transmissions in a fibre channel network. For example, a node can be a computer system, a storage device/subsystem, a storage router/bridge that connects SCSI equipment, a printer, a scanner, or any other equipment, such as data capture equipment. The ANSI X3.272-1996 specification entitled “FC-AL, Fibre Channel Arbitrated Loop” and the ANSI X3.T11 Project 1133-D specification entitled “FC-AL-2, Fibre Channel Arbitrated Loop” describe examples of fibre channel loop topologies in further detail. The ANSI X3.T11 Project 959-D specification entitled “FC-SW Fibre Channel Switch Fabric” describes an example of a fibre channel fabric in further detail. Note that the most recent versions of these and related specifications may be obtained from the T11 technical committee of the National Committee for Information Technology Standards (NCITS).

For point-to-point topologies and loop topologies, device drivers executing on a host computer perform device discovery at host boot-up to determine locally connected devices. The discovered devices are configured to be accessible to applications running on the host by creating a node for each device within the host. These types of nodes are referred to as operating system device nodes. Each node functions as an internal (to the host) representation of an attached device and provides a communication path to the device. Since the number of devices attached to a host in point-to-point and loop topologies are limited, the discovery process may be completed within an acceptable time frame. Due to the number of devices capable of being attached to a fabric, discovering all fabric devices available to the host at host boot-up may not be feasible. Additionally, a host computer may desire to maintain its fabric device configuration across reboots and adjust for changes in the fabric.

### SUMMARY OF THE INVENTION

Methods, systems, and programs for maintaining a fabric-attached device configuration in regard to fabric state changes for a host system connected to a fabric are described for various embodiments of the present invention. An event may be received indicating a fabric state change for one or more host adapter ports. In response to the event, the host system's fabric device configuration may be dynamically changed. Dynamically changing the host system's fabric device configuration may include bringing online or taking offline one or more fabric devices for the one or more host adapter ports for the host system.

In some embodiments, a configuration file may be stored specifying an action to be taken for various types of events. Upon receiving indicating a fabric state change, the configuration file may be accessed to determine the fabric device configuration action to be taken for the type of fabric state change indicated by the event.

### BRIEF DESCRIPTION OF THE DRAWINGS

FIG. 1 illustrates a host computer attached to a fabric and one or more local devices;

FIG. 2 illustrates an example of a storage area network (SAN) suitable for implementing various embodiments of the present invention;

FIG. 3 is a flowchart illustrating an on-demand node creation process according to an embodiment of the present invention;

FIG. 4 illustrates an example of a storage network suitable for implementing various embodiments of the present invention;

FIG. 5 is an illustration of a host computer coupled to a fabric according to one embodiment of the present invention;

FIG. 6 is a flowchart illustrating a device discovery process, according to one embodiment of the present invention;

FIG. 7 is a flowchart illustrating an on-demand device node creation process, according to one embodiment of the present invention;

FIG. 8 is an illustration of a system coupled to a fabric according to an embodiment of the present invention;

FIG. 9 is a flowchart of an on-demand node creation process for fibre channel fabrics according to an embodiment of the present invention;

FIG. 10 is a flow chart illustrating a method for onlining selected fabric devices on-demand from a list of fabric devices, according to one embodiment of the present invention;

FIG. 11 is a flowchart illustrating a mechanism for dynamically updating a persistent repository to reflect a changes a in the fabric, according to one embodiment of the present invention;

FIG. 12 is a flowchart illustrating a mechanism to allow a host's fabric device configuration to persist across reboots and shutdowns, according to one embodiment of the present invention;

FIG. 13 is a diagram illustrating components for providing dynamic node reconfiguration in response to fabric state change events, according to one embodiment of the present invention;

FIG. 13A is an illustration of modules which may be included in a fabric driver according to one embodiment of the present invention;

FIG. 14 is a flow chart illustrating an event driven node configuration process in response to dynamic changes in fabric connectivity, according to one embodiment of the present invention;

FIG. 15 illustrates a system including a host adapter configuration file, according to one embodiment of the present invention;

FIG. 16 is a flowchart illustrating an event driven configuration process for an event in which a host adapter loses connectivity to the fabric, according to one embodiment of the present invention;

FIG. 17 is a flowchart illustrating an event driven configuration process for an event in which a host adapter acquires or regains connectivity to the fabric, according to one embodiment of the present invention; and

FIG. 18 illustrates a flowchart for an event driven configuration in regard to a fabric state change of the connection of a new fabric device, according to one embodiment of the present invention.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS OF THE INVENTION

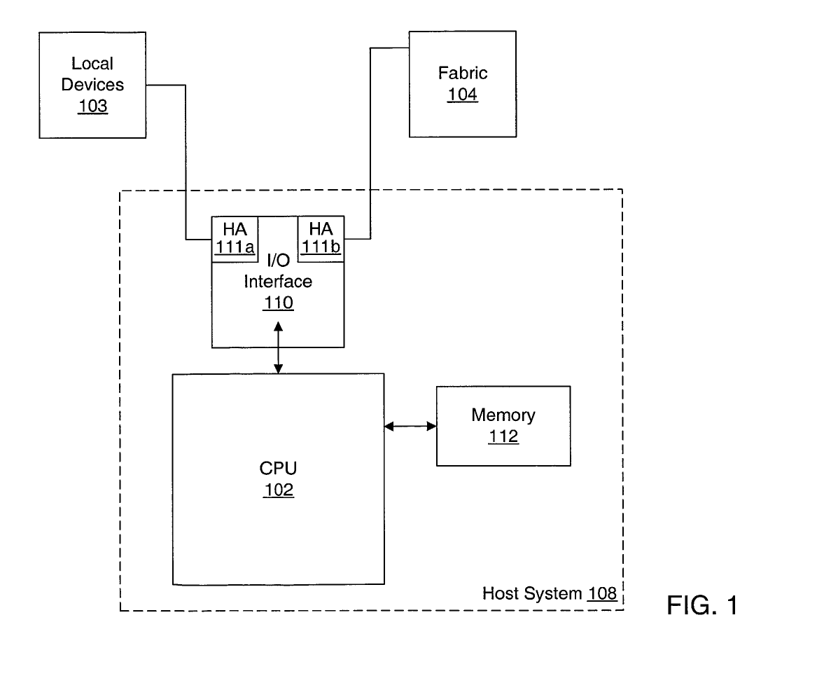

FIG. 1 illustrates a host system 108 attached to a fabric 104, which is suitable for implementing various embodiments of the present invention. The host system 108 may include at least one central processing unit (CPU) or processor 102. The CPU 102 may be coupled to a memory 112. The memory 112 is representative of various types of possible memory media (also referred to as “computer readable media”): for example, hard disk storage, floppy disk storage, removable disk storage, flash memory or random access memory (RAM). The terms “memory” and “memory medium” may include an installation medium, e.g., a CD-ROM or floppy disk, a computer system memory such as DRAM, SRAM, EDO RAM, SDRAM, DDR SDRAM, Rambus RAM, etc., or a non-volatile memory such as a magnetic media, e.g., a hard drive, or optical storage. The memory medium may include other types of memory as well, or combinations thereof. In addition, the memory medium may be located in a first computer in which the programs are executed, or may be located in a second different computer which connects to the first computer over a network. In the latter instance, the second computer provides the program instructions to the first computer for execution.

As shown in FIG. 1 the memory 112 permits two-way access: it is readable and writable. The memory 112 may store instructions and/or data which implement all or part of the system and method described in detail herein, and the memory 112 may be utilized to install the instructions and/or data. In various embodiments, the host system 108 may take various forms, including a personal computer system, desktop computer, laptop computer, palmtop computer, mainframe computer system, workstation, network appliance, network computer, Internet appliance, personal digital assistant (PDA), embedded device, smart phone, television system, or other suitable device. In general, the term “computer system” may be broadly defined to encompass any device having a processor which executes instructions from a memory medium.

The host system 108 may be coupled to a fabric 104, which may provide access to a plurality of fabric attached devices, such as persistent storage devices or other computer peripheral devices. The CPU 102 may acquire instructions and/or data through an input/output interface 110. Through the input/output interface 110, the CPU 102 may also be coupled to one or more local devices 103, such as local input/output devices (video monitors or other displays, track balls, mice, keyboards, etc.) local storage devices (hard drives, optical storage devices, etc.), local printers, plotters, scanners, and any other type of local I/O devices for use with a host system 108. Some local devices may be referred to as direct attach devices. Input/output interface 110 may include host adapters 111a and 111b for coupling to local devices 103 and fabric 104 respectively. Host adapters 111a and 111b may be fibre channel adapters (FCAs). In one embodiment, one or more of the local devices may be included in the host system 108, such as in expansion slots of the host system 108. In one embodiment, one or more of the local devices may be externally connected to the host system 108.

The host system 108 may be operable to execute one or more computer programs. The computer programs may comprise operating system or other system software, application software, utility software, Java™ applets, and/or any other sequence of instructions. Typically, an operating system (OS) performs basic tasks such as recognizing input from the keyboard, sending output to the display screen, keeping track of files and directories on the disk, and controlling peripheral devices such as disk drives and printers. Application software runs on top of the operating system and provides additional functionality. In one embodiment, the OS may be based on Sun Microsystems's Solaris™ operating system. The computer programs may be stored in a memory medium or storage medium such as the memory 112, or they may be provided to the CPU 102 through the fabric 104 or I/O interface 110.

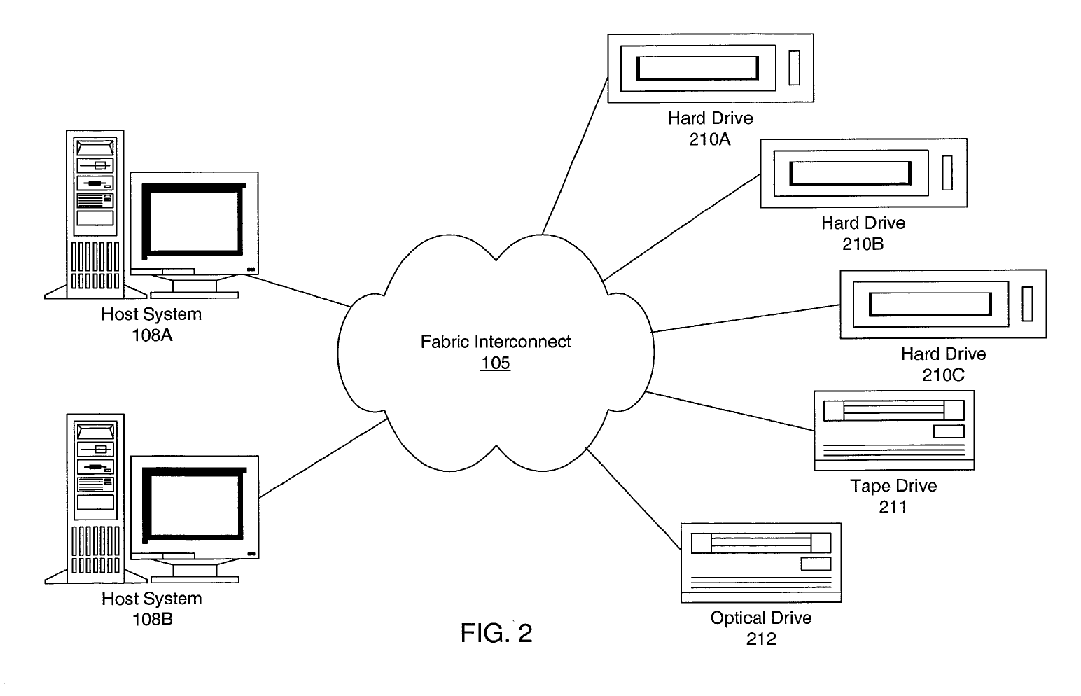

FIG. 2 illustrates an example of a SAN coupled to host computers 108A and 108B. The SAN shown in FIG. 2 includes a fabric interconnect 105 coupled to hard drives 210A, 210B, and 210C, tape drive 211, and optical drive 212. Hard drives 210A, 210B, and 210C, tape drive 211, and optical drive 212 are also referred to as fabric devices. It should be noted that the number and types of hosts and devices shown in FIG. 2 are for illustration purposes only, and the actual number and types of hosts and/or devices in a SAN may vary. Fabric interconnect 105 may include one or more switches which are connected to the network nodes with an optical, copper cable, or other type of cable or interconnect medium.

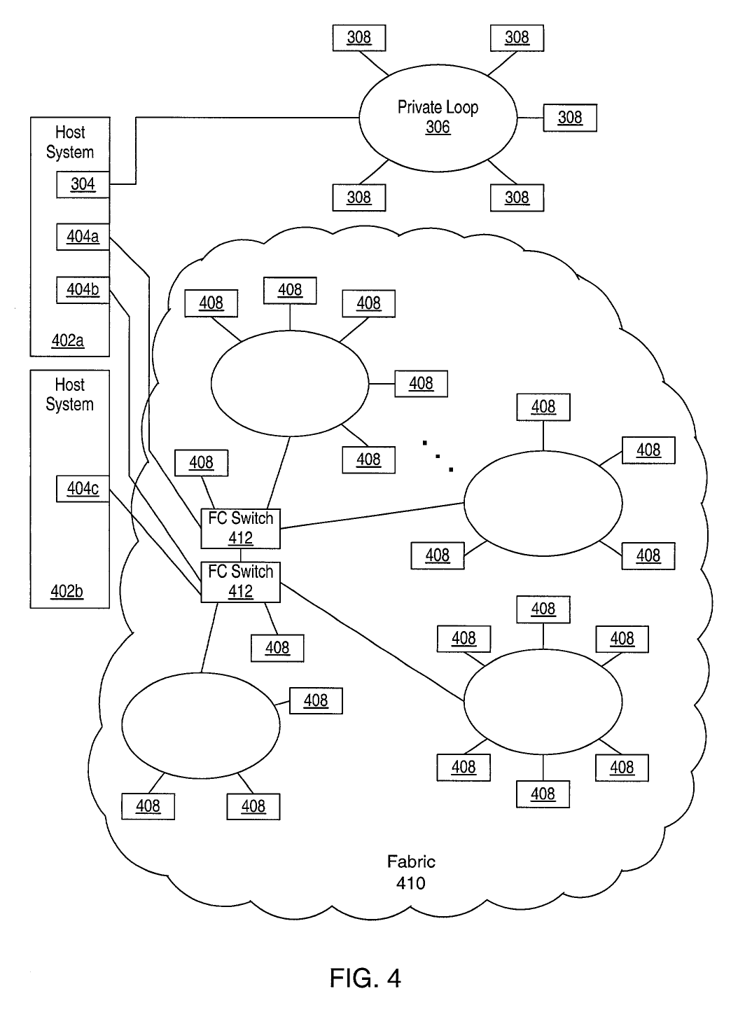

FIG. 4 illustrates an example of a storage network which includes a direct attached private loop 306 and a fabric 410. It should be noted that storage networks may be configured in a variety of different ways and many include one or more direct attach devices, SANs, and/or network attach (NAS) devices. Furthermore, it should be noted that fabrics and/or SANs are not limited to fibre channel technologies and architectures but may include various types of technologies. For example, some or all of a SAN may be based on the InfiniBand™ Architecture or iSCSI (SCSI over IP).

Host adapter 304 couples host system 402a to private loop 306 and adapters 404a and 404b couples host system 402b to fabric 410. Note that host adapters 304, 404a and 404b may be separate host bus adapter cards, for example. In other embodiments, host adapters 304, 404a and 404b may each refer to a separate host adapter port. Coupled to private loop 306 are one or more direct attach devices 308. Direct attach device(s) 308 are considered local to host system 402a.

The host system 402b is coupled to fabric 410 via host adapter 404c. Fabric 410 includes fibre channel switches 412 which are coupled to multiple fabric devices 408. Each fibre channel switch may connect to various fibre channel topologies such as point-to-point fibre channel connections or fibre channel loops. Each switch may also connect to one or more other fibre channel switches. The fabric devices 408 may be various storage devices such as hard disk drives, optical drives, tape drives, etc. In some embodiments fabric devices 408 may be any type of I/O device such as storage devices, printers, scanners, etc. as are used in conjunction with computer systems.

Due to the large number of devices which may be present in fabric 410, the time required for a host system 402 to discover and online all of the devices available through fabric 410 may be impractical. Furthermore, it may be unlikely that host system 402 actually needs to communicate with all of the various fabric devices 408. The term “online” may be used herein to refer to creating a node to provide a communication mechanism or path to a device.

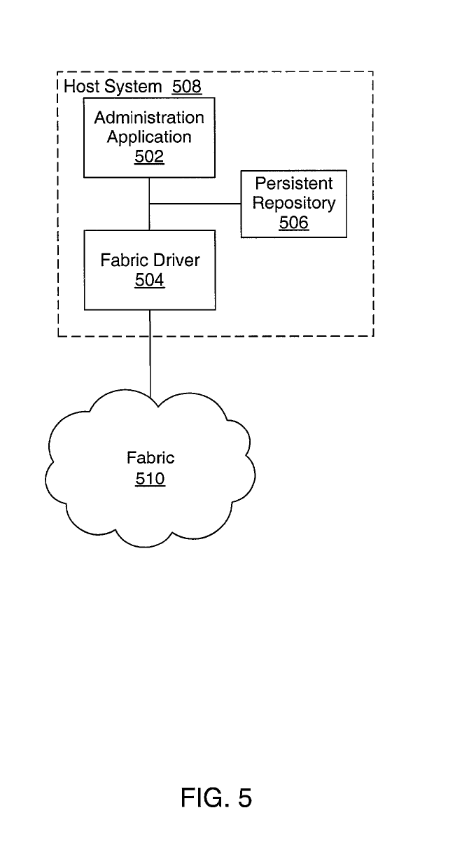

FIG. 5 illustrates a host system 508 coupled to a fabric 510 according to one embodiment of the present invention. The fabric 510 may be implemented with one or more switches coupled to one or more storage devices or subsystems. Furthermore, it should be noted that fabric 510 is not limited fibre channel fabrics but my be extended to any type of switched storage network. A fabric driver 504 provides an interface between host system 508 and fabric 510. A persistent repository 506 is a data structure that stores information on the current status of the fabric devices. An administration application 502 is a software program running on host system 508 and accessible to a system administrator. Administration application 502 provides a mechanism for discovering fabric devices on-demand with user input thereby eliminating the need to discover all fabric devices accessible to a host system at one time. As such, nodes can be created only for selected fabric devices (i.e., a subset of available fabric devices) during a discovery process. It should be noted that if a node is already created for a selected fabric device, it may not be necessary to re-create the node.

During a discovery process, administration application 502 may query a fabric driver 504 for a list of devices visible to the host system 508. Fabric driver 504 provides an interface for the host system to the fabric. Fabric driver 504 may be part of the operating system for the host system and may include one or more modules for handling various functions required to interface the host system to the fabric such as protocol handling and transport layer operations. In one embodiment of the present invention, the fabric driver 504 may be a Solaris kernel module or modules. The fabric driver 504 may provide the requested list of devices to the administration application 502. A subset of these devices may then be selected through administration application 502 and brought online by fabric driver 504 so that the subset of devices are accessible from host system 508. Onlining the subset of devices may include the creation of a node within the operating system for each device wherein the node provides a reference for applications or other processes in host system 508 to reference a corresponding device in fabric 510. Thus, a node provides a path for an application or process running on the host system to communicate with one of the fabric devices. Thus, when a fabric device is onlined, a communication path may be established between the host system 508 and the discovered fabric device.

Administration application 502 thus provides a mechanism to select and online only a subset of the visible fabric devices. Also administration application 502 may be run outside of the boot process so that device discovery and online operations do not increase the host system boot time. The administration application 502 may be run on-demand so that fabric devices may be selected and brought online on demand. For one embodiment of the present invention, a system administrator may use administration application 502 to request a list of fabric devices available through one or more host adapter I/O ports of host system 508. Administration application 502 may include a command line interface or a graphical user interface (or both) for displaying the list to the system administrator. Through this interface the system administrator may then select a desired subset of the listed devices and request that the selected devices be brought online.

The fabric driver 504 provides APIs for the administration application 502 to make queries in order to obtain a list of devices connected to one or more host adapter ports. In one embodiment a transport layer of the fabric driver 504 may execute the query irrespective of the interconnect topology of the host adapter ports. For example, the fabric driver may obtain the list of devices connected to a fibre channel switched fabric by querying a fabric name server. The fabric name server may be located within a fabric switch or distributed across the fabric switches and maintains information about the various fabric devices. The fabric name server may include a database of objects. Each fabric attached device may register or query useful information in the name server, including, name, address, class of service capability of other participants, etc. The fabric driver may also provide an API for obtaining a list of direct attach devices for a host. For example, the fabric driver may obtain the loop map for a host system's private loop topology.

For direct attach devices, e.g. private loop topologies, operating system device nodes may be created during driver attach (e.g., when the fabric driver is loaded during a reboot) for all devices visible through a direct attach port. In some embodiments, operating system device nodes are only created for direct attach devices that support a particular protocol (e.g., FCP/SCSI).

For fabric topologies connected to the host system 508, operating system device nodes may not be created until an on-demand request is made by the administration application 502. As discussed above, upon such a request from the administration application 502, the fabric driver 504 provides a list of devices visible through one or more fabric host adapter ports. The fabric driver 504 may obtain the list by accessing a fabric name server. The list of fabric devices may be provided by the administration application 502 to a system administrator, for example, through a graphical user interface. The system administrator may use the administration application 502 to select and online particular devices which are desired to be used by the host system 508. The administrator may also use administration application 502 to offline any devices which are no longer needed. Offlining may be removing access to a storage device form the host operating system by removing the node. The list of devices displayed to the administrator by the administration application 502 may include the information returned about the fabric devices by the fabric name server. The administration application 502 may request the fabric driver 504 to online or offline fabric devices as indicated by a system administrator using the application's user interface. In some embodiments, the administration application 502 may make requests to fabric driver 504 to obtain fabric device information and/or to online/offline fabric devices without the involvement of a system administrator. For example, certain events or requests from other processes may trigger administration application 504 to online a fabric device(s).

The persistent repository 506 may be stored in the host system 508, or in some central local accessible to host system 508, indicating the current fabric devices which have been onlined (e.g., devices for which an operating system device node has been created). The information stored in the persistent repository 506 may be used so that the configuration of devices online for the host system 508 persists across reboots and shutdowns. For example, when the host system 508 is rebooted the persistent repository may be read to determine which devices were online before the reboot and the fabric driver may be requested to online these same devices again.

The persistent repository 506 may be dynamically updated to reflect the state of the fabric devices. For example, if a fabric device which is currently online for the host system 508 is disabled on the fabric (for example, a hard drive fails or is removed from the fabric), fabric driver 504 may generate an event causing the persistent repository to be updated to reflect that the device is now offline. Similarly, if the same device later is restored on the fabric, the device may be onlined again (e.g. in response to an event) for the host system 508 and the persistent repository dynamically updated to reflect the onlined status.

Although fabric 510 may include an extremely large number of fabric devices, the query operations made by administration application 502 to obtain a list of the fabric devices may be made on a per host adapter port granularity or a set of host adapter ports granularity so that the number of devices returned by the query may be a manageable number.

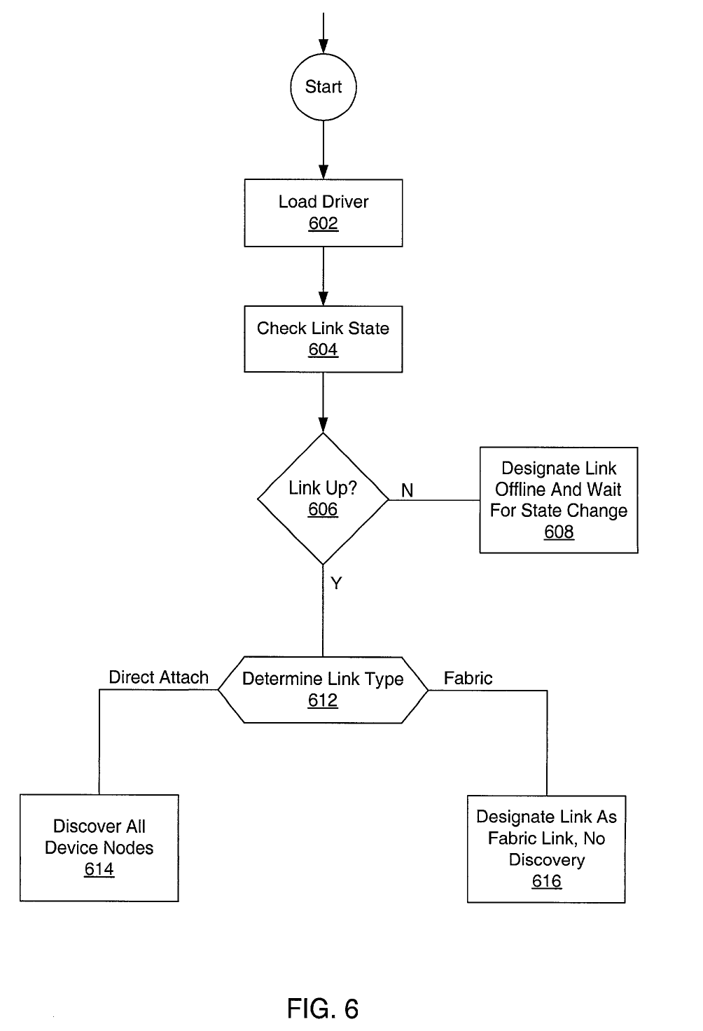

Turning now to FIG. 6, a flowchart is provided illustrating a device discovery process according to one embodiment of the present invention. The discovery process may be part of a host system reconfiguration boot process. Alternatively, if a non-reconfiguration boot is performed of the host system in which device discovery is not performed, the discovery process may run when a previously created device node is accessed in the host system. This discovery process may also be performed if the host system's host adapter link is lost (e.g. cable pulled out).

During the discovery process a fabric driver is loaded as indicated at 602. Note that if the fabric driver is already loaded, then it may no be necessary to load the fabric driver again. The link state of each host adapter port may be checked as indicated at 604 and 606. If a port's link is down, the link may be designated as offline as indicated at 608, and the discovery process for that link may wait for a state change in the link to online, as indicated at 610. If the link is later restored, the discovery process may continue for that link.

If the link is up, the link type is determined, as indicated at 612. In one embodiment, a fabric login is attempted through the link. If the fabric login is successful, the link is determined to be a fabric link. If unsuccessful the link is determined to be a direct attach link. For a direct attach link, the one or more direct attach devices are discovered and brought online by creating operating system device nodes for each direct attach device. If the link is a fabric link, the link is designated as such, but no device discovery or onlining of devices is performed for the fabric link as part of this discovery process, as indicated at 616. The discovery process as illustrated in FIG. 6 may be repeated any time a link goes out (e.g., cable pulled, power off, host reboot, etc.).

The device discovery process illustrated in FIG. 6 provides for the discovery and onlining of direct attach devices since the discovery and onlining of such devices may be completed quickly due to the limited number of such devices. However, for a host system's fabric links, device discovery is not performed as part of the normal discovery process performed at reconfiguration boot up or the first time a node is attempted to be accessed after a link has been down and brought back up. Instead, fabric devices may be discovered using the on-demand node creation process described herein.

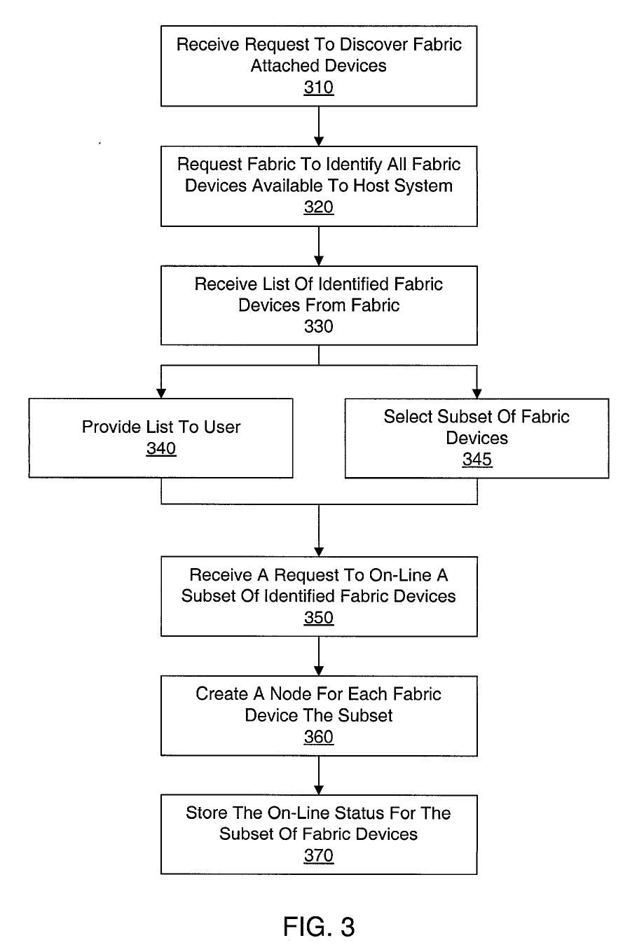

One embodiment of the on-demand node creation process is illustrated by the flowchart of FIG. 3. A request may be received to discover fabric attached devices, as indicated at 310. In response to the request to discover fabric attached devices, a fabric may be requested to identify fabric devices available to a host system, as indicated at 320. A list of identified fabric devices may be received from the fabric, as indicated at 330. Note that the term “list” simply refers to the information provided by the fabric driver and does not require any particular format.

This list may be provided to a user for selection of a subset of the fabric devices, as indicated at 340. Alternatively, selection of a subset of the fabric devices may be performed without user involvement, as indicated at 345. A request may be received to on-line the subset of identified fabric devices, as indicated at 350. In response to the request to on-line the subset of identified fabric devices, a node may be created for each fabric device of the subset not already on-line, as indicated at 360. The node provides a mechanism for processes to communicate with the corresponding device from the host system. The on-line status on each fabric device of the subset may be stored, as indicated at 370.

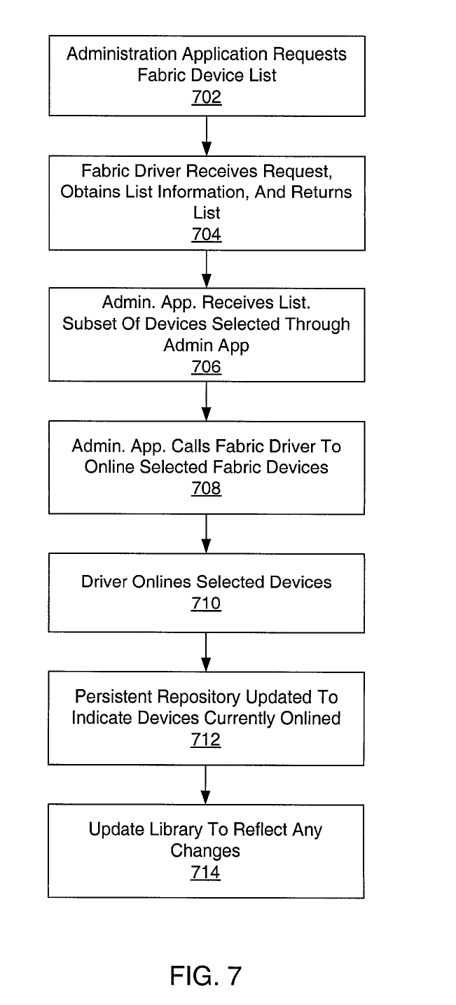

Another embodiment of the on-demand node creation process is illustrated by the flowchart of FIG. 7. An administration application may make a request for a list of fabric devices, as indicated at 702. This request may have been initiated by a system administrator using the administration application for the host system. In other embodiments, this process may be initiated automatically, for example in response to an event (e.g. fibre channel protocol event) or a request from another application or process. A fabric driver may receive the request from the administration application as indicated at 704. The fabric driver may access a fabric name server to obtain the requested information and return the requested list of fabric devices to the administration application. Note that the term “list” simply refers to the information provided by the fabric driver and does not require any particular format.

The administration application may receive the list and a subset of devices may be selected from the list, as indicated at 706. In one embodiment the list may be displayed through a graphical user interface to a system administrator. In other embodiments, a command line or textual user interface is used. The system administrator may select particular devices from the list to be onlined or offlined. The administration application may then call the fabric driver to online or offline devices as indicated by the selections made for the subset of devices from the list, as indicated at 708. The driver may then attempt to online the devices selected to be onlined (and may offline the devices selected to be offlined), as indicated at 710. Onlining a device may include the creation of an operating system device node for that device. The device node provides a mechanism for processes to communicate with the corresponding device from the host system.

A persistent repository may be updated (or created if not already existing) to indicate which devices are currently online, as indicated at 712. During operation, the persistent repository may be updated to reflect any changes in fabric devices. For example, if a device indicated by the persistent repository to be currently onlined is removed from the fabric the persistent repository may be updated accordingly as indicated at 714. Changes in the fabric may be detected by an event generated in the fabric and communicated to the administration application (or library) by the fabric driver.

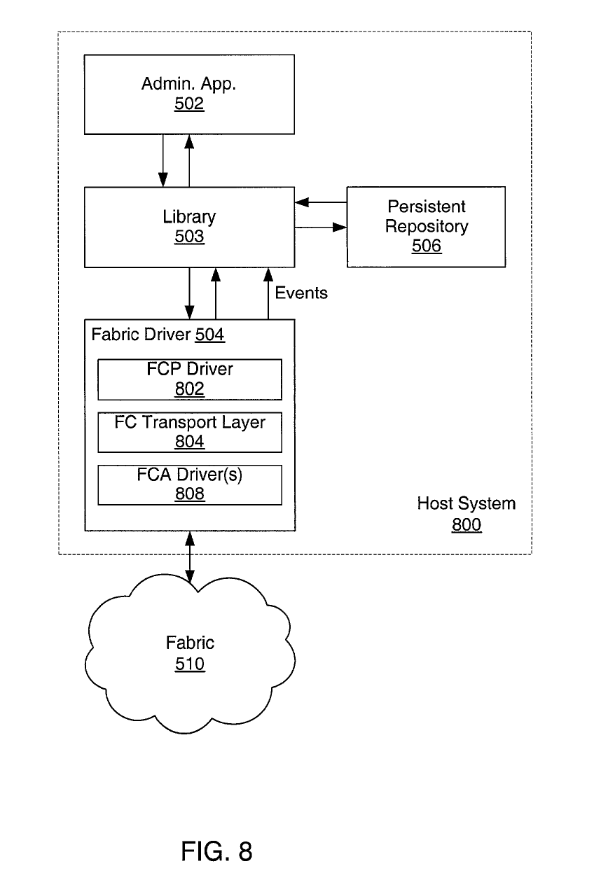

FIG. 8 illustrates a host system 800 coupled to a fabric 510 according to one embodiment of the present invention. The host system 800 includes a fabric driver 504 for communicating with a fibre channel fabric. A library 503 may be provided as an interface between the administration application 502 and the fabric driver 504. The library may be made part of the operating system libraries and may be useable by other applications on the host system. For one embodiment of the present invention, fabric driver 504 may include various sub-modules. For example, in a fibre channel implementation, the fabric driver may include a fibre channel protocol driver module (FCP) 802. The FCP module may be part of the operating system kernel and may perform all protocol related operations required for fibre channel use on the host operating system. For example, FCP module 802 may be a SCSI over fibre channel encapsulation driver module for supporting SCSI over fibre channel. Driver 504 may also include a transport layer 804. This module may perform all generic fabric operations. In one embodiment transport layer 804 may include a fibre channel port (FP) driver for each fibre channel port on the host system. Each FP driver may also be part of the operating system kernel. The FP driver performs all generic fibre channel operations such as topology discovery (e.g., loop, point-to-point, fabric, etc.), device discovery (on various topologies), handling extended link services, handling link state changes, etc. The fabric driver 504 may also include host adapter drivers 808 for each host adapter/controller board on the host system. For example FCA drivers may be present for fibre channel adapters having fibre channel ports on the host system.

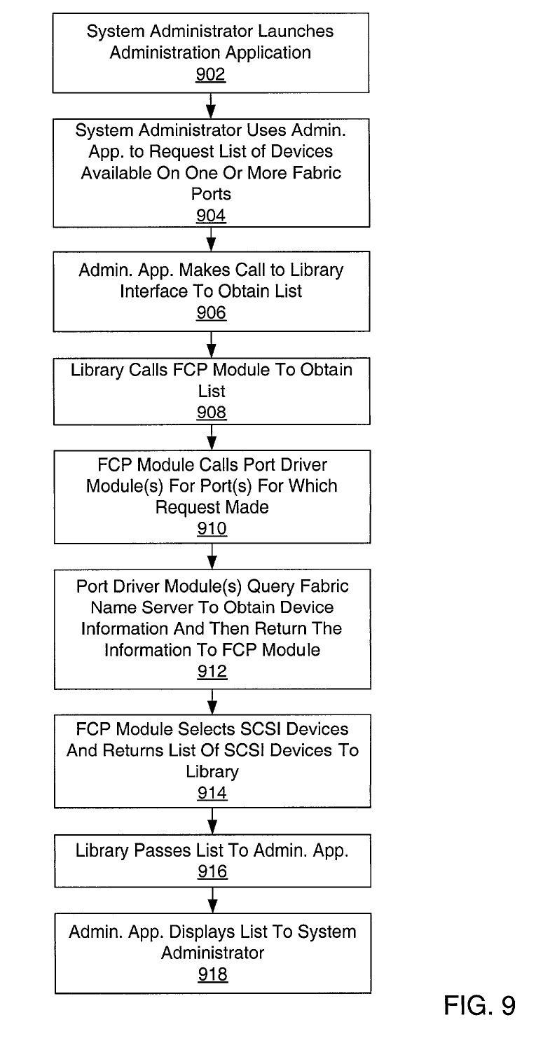

FIG. 9 illustrates a more detailed flowchart of the on-demand node creation process for fibre channel host adapter ports of a host system. In one embodiment, the host system may be executing a UNIX type operating system such as the Solaris™ operating system from Sun Microsystems. A Solaris operating system and fibre channel fabric will be assumed by way of example in the following description.

A user (e.g. system administrator, other process, etc.) may launch or access the administration application to obtain a list of devices available on a fabric port (e.g. FCA port), as indicated at 902. For example, a system administrator may interface to the administration through a graphical user interface (GUI), command line use interface, etc. Through the user interface, the system administrator may query for devices available on a single port or on a set of ports, as indicated at 904. On Solaris, for example, an FCA port may have a file system representation of the form, e.g., /devices/pci@1f,0/pci@1/SUNW,qlc@4/fp@0,0:fc.

One or more library interfaces may be provided as an interface between the administration application and the fabric driver. This library interface(s) may be made part of the operating system's standard storage libraries. The administration application may then call one or more of the library interfaces to obtain the list of devices, as indicated at 906. These libraries may be shared between the administration application and other storage applications. The library calls into the fabric driver to obtain the list of devices, as indicated at 908.

In one embodiment, the library calls into an FCP module using the standard driver IOCTL interface (the call may actually be made into an FP module which merely passes on the IOCTL call to the FCP module) to obtain the list of devices. The library may then wait for the FCP module to return the list. The FCP module may then make a call into a port driver module(s) to obtain the list of fabric devices available through the fabric port(s) on which the request was made, as indicated at 910. For example, the FCP module may call an FP module(s) using the FC transport APIs between ULPs and the FC transport to obtain the list of fabric devices available through the FCA port(s) on which the request was made.

The fabric driver (e.g. port driver module(s) of the fabric driver) then obtains the device information from the fabric. In one embodiment, the FP module(s) may query a NameServer on the fabric (the Name Server may be maintained by FC switches) to obtain the list of FC ports and return this list to FCP, as indicated at 912.

In one embodiment, the fabric driver may check the list for devices following a particular protocol and return a list of those devices to the administration application library interface. For example, the FCP module may check for SCSI ports from the received list (e.g. disks and tapes) and return the list of SCSI capable FC ports to the library, as indicated at 914. In another embodiment, the list may include selective LUNs (logical units) behind an FC port. The library may then pass this list on to the administration application, as indicated at 916. The administration application may then display the list through its user interface, as indicated at 918.

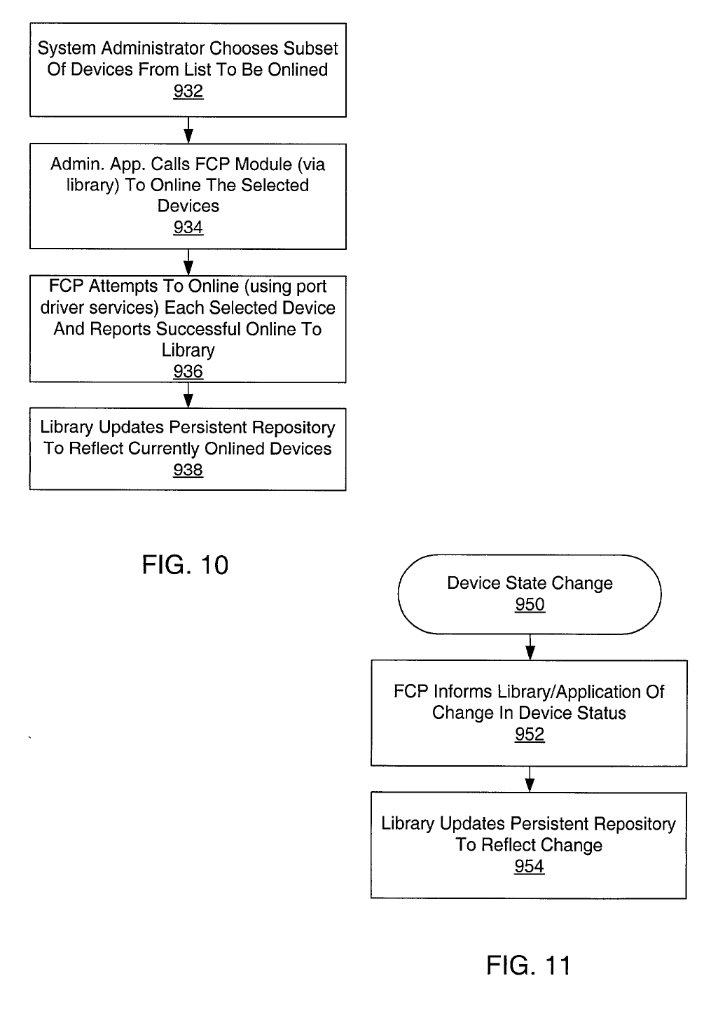

Turning now to FIG. 10, a flow chart is provided illustrating a method for onlining selected fabric devices on-demand from a list of fabric devices, according to one embodiment. In one embodiment, a list of fabric devices may have been obtained by the method illustrated in FIG. 9. A user (e.g. system administrator, other process, etc.) chooses a subset of devices from this list to online and passes this list of devices to the administration application, as indicated at 932. The administration application may then call the fabric driver to online the selected devices. For example, the administration application may call an FCP module (via a library interface) to online the selected devices, as indicated at 934. The FCP module, using the services of FP module(s), attempts to online each of the selected devices in the list and reports each successful online to the library, as indicated at 936. For every device successfully onlined by the FCP module, the administration application library interface updates a persistent repository to reflect devices currently onlined, as indicated at 938. Note also that offlining a node through the administration application may cause an event to be generated to trigger an update the persistent repository.

Turning now to FIG. 11, one embodiment is illustrated of a mechanism for dynamically updating the persistent repository to reflect changes that occur in the fabric. A device state change may occur in the fabric, as indicated at 950. For example, a fabric disk drive online for the host system may be removed from the fabric. An event may be generated to indicate this change. The FCP module may inform the library/application of such changes that effect the device list, as indicated at 952. The administration application library interface may update the contents of the persistent repository in response to receiving notification of a change, as indicated at 954, so that the persistent repository is dynamically updated to reflect such changes. The persistent repository may be stored, for example, on persistent storage such as a disk drive or non-volatile memory.

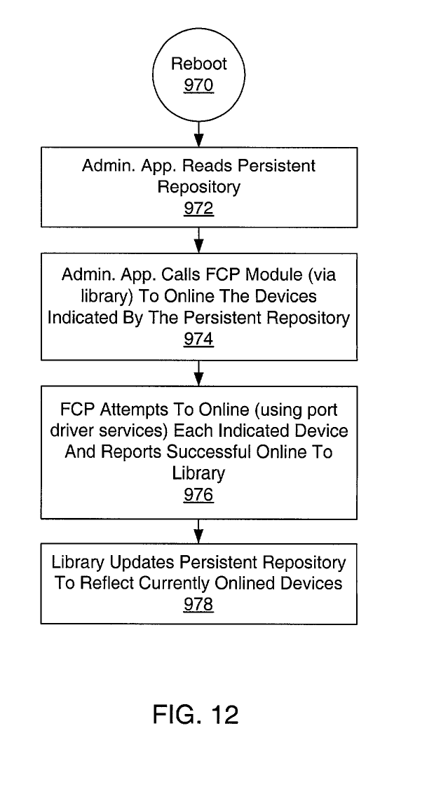

The persistent repository may allow a host's fabric device configuration to persist across reboots and shutdowns, as illustrated in FIG. 12 for one embodiment. On a host reboot (970), a component of administration application (e.g. in the Solaris ‘rc’ scripts) reads the persistent repository to determine which devices were previously online, as indicated at 972. The administration application then calls the fabric driver (via the library) to online the fabric devices that were onlined prior to the reboot, as indicated at 974. The fabric driver attempts to online each device indicated by the persistent repository and reports successful onlines to the library, as indicated at 976. The library may then update the persistent repository to reflect the currently online devices, as indicated at 978.

An example of an entry in a persistent repository is: /devices/pci@1f,4000/pci@2/SUNW,qlc4/fp@0,0:fc::50020f23000000e6. In this example, the entry identifies the /devices path to an onlined FC port. In other embodiments, additional information may be included. For example, the repository may identify onlined fabric devices on a per LUN basis.

As discussed above, fabric devices may be efficiently configured for access through a host adapter port on a host computer by using an on-demand node creation process. Also, a persistent repository may store an indication of fabric devices that are online through each host adapter port. The persistent repository may be used to maintain the node configurations for each host adapter port across reboots and shutdowns. Thus, fabric devices may initially be configured, for example, through an administration application which initiates node configuration requests for selected fabric devices. If the host system is rebooted, the previous fabric device node configurations may be restored by accessing the persistent repository to determine the previously onlined fabric devices and bringing those devices online again.

Other changes may also occur in the fabric, or in the host system's connectivity to the fabric, for which it may be desirable to alter the fabric device node configuration for the host system. It may be desirable to dynamically reconfigure a host's fabric device node configuration in response to fabric state changes as those changes are detected. For example, a host adapter providing the interface between a host computer and the fabric may become disconnected from the fabric. The host adapter may lose its connection to the fabric because of, for example, an adapter failure, or cable disconnection, or driver detachment, etc. Later, the host adapter may be dynamically restored during operation of the host computer. A mechanism may be provided to reconfigure (e.g. perform node creation for) the fabric devices that were online through the host adapter prior to its restoration.

Another dynamic fabric state change that may occur is the addition of a new device to the fabric visible through a host adapter port of the host computer. A host computer may desire to be able to access all newly added fabric devices through a particular host adapter port. A dynamic node creation mechanism may be provided to dynamically configured newly connected fabric devices through a host adapter port.

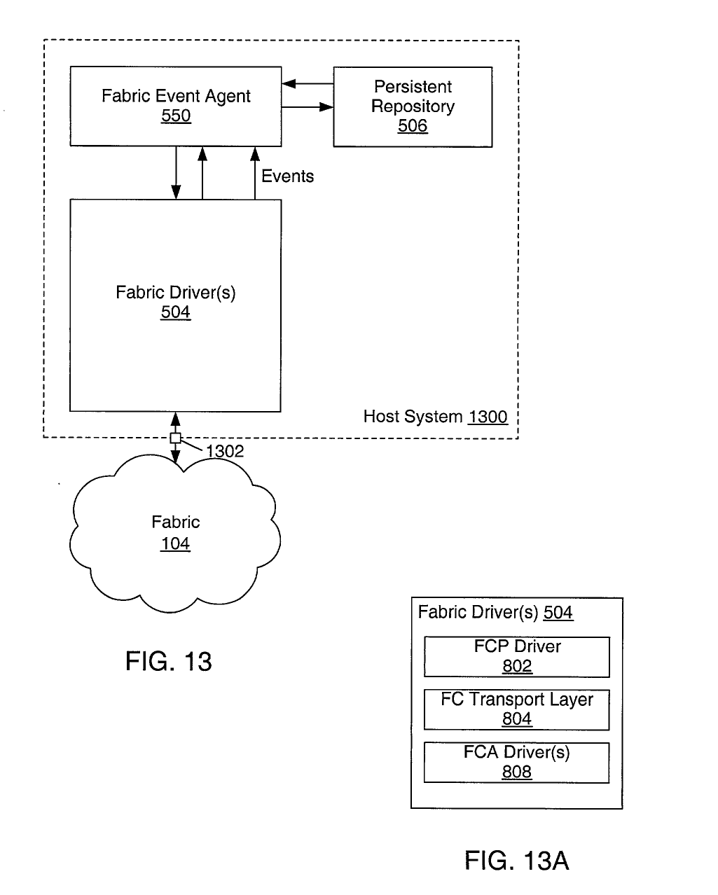

Turning now to FIG. 13, a diagram is provided illustrating components for providing dynamic node reconfiguration for a host system 1300 in response to fabric state change events. The host system 1300 may have one or more ports 1302 for coupling to a fabric. A fabric event agent 550 may be provided for detecting fabric state changes and responding accordingly. Fabric event agent 550 may be a software module on the host system that interfaces with fabric driver 504 and persistent repository 506. In one embodiment, fabric event agent 550 may be part of the operating system libraries 503 as discussed in connection with FIG. 8.

Fabric event agent 550 may receive events from fabric driver 504 indicating a state change in the fabric connectivity. In one embodiment fabric event agent 550 registers with a system event framework of the host operating system to listen to events related to one or more fabric adapter ports of the host system.

One type of event monitored by fabric event agent 550 may be events indicating changes in the connectivity of a host adapter port to the fabric. For example, an event may be generated through or by fabric driver 504 if a host adapter port loses connection to a fabric. A host adapter port may lose connection to the fabric for a variety of reasons. One such reason may be a physical disconnection of the cable or interconnect to the host adapter. Another reason may be a failure in the host adapter. A host adapter may be an I/O system board, host bus adapter card, or other circuitry on or connected to the host system. If, for example, a host bus adapter card fails, the failure may be detected by the fabric driver and an event may be generated indicating that the host adapter is down. In some embodiments an event indicating that a host adapter port is no long available may be generated when the driver for that host adapter (e.g. FCA driver 808, see FIG. 8) detaches. A host adapter driver may detach upon detecting a host bus adapter card failure or may be manually detached (e.g. disabled). Thus, an event may be generated to indicate the loss of host adapter connectivity to the fabric for a variety of different reasons.

If fabric event agent 550 receives an event indicating a loss of host adapter connectivity for one or more host adapter ports, the fabric event agent 550 may take appropriate action. For example, those fabric devices which were onlined through the lost host adapter may be unconfigured. Fabric event agent 550 may request an unconfigure operation for the fabric devices that were configured or onlined through the lost host adapter port or ports. The fabric event agent 550 may access the persistent repository 506 to determine which fabric devices were onlined through the lost host adapter (or host adapter port). The unconfigure operation may disable the operating system nodes for the fabric devices that were configured through the lost host adapter. It may be desirable to disable these nodes so that other processes or application executing on the host system do not attempt to use fabric devices that are no longer available from the host system.

When a host adapter is restored, an event may be generated to indicate that the host adapters connectivity to the fabric is now available. In one embodiment, such an event may be generated upon host adapter driver attach. In response to such an event, fabric event agent 550 may access persistent repository 506 to determine fabric devices that were previously online for the now-restored host adapter. Fabric event agent 550 may request a configuration operation (node creation) for the fabric devices that were previously onlined for a particular host adapter or host adapter port. Thus, a dynamic node creation mechanism is provided to respond to the restoration of connectivity to the fabric through a host adapter. If a host adapter is replaced, repaired, cable reconnected, driver reattached, etc., the fabric device nodes that had previously existed in regard to that host adapter may be recreated. The reconfiguration operation to recreate a previous node configuration for a restored host adapter may involved verifying the fabric devices indicated by the persistent repository for the restored host adapter, and then performing node creation for the verified fabric devices.

Another type of fabric connectivity state change that may be detected by the fabric event agent 550 is an event indicating a newly connected fabric device visible through a particular host fabric adapter. A host system may have a policy of configuring any newly connected fabric device for a particular host fabric adapter. In some embodiments a host may have a policy of configuring any newly connected fabric device of a particular type, such as storage devices, visible through a particular host adapter. If fabric event agent 550 receives an event indicating a newly connected fabric device through a host adapter, the fabric event agent 550 may request a configuration operation for the newly connected fabric device. The configuration operation may be a node creation operation to create an operating system node to make the newly connected fabric device accessible for the host system through the host adapter. The persistent repository 506 may be updated to indicate that the newly connected fabric device is online through the particular host adapter.

For one embodiment of the present invention, fabric driver 504 may include various sub-modules as illustrated in FIG. 13A. For example, in a fibre channel implementation, the fabric driver may include a fibre channel protocol driver module (FCP) 802. The FCP module may be part of the operating system kernel and may perform all protocol related operations required for fibre channel use on the host operating system. For example, FCP module 802 may be a SCSI over fibre channel encapsulation driver module for supporting SCSI over fibre channel. Driver 504 may also include a transport layer 804. This module may perform all generic fabric operations. In one embodiment transport layer 804 may include a fibre channel port (FP) driver for each fibre channel port on the host system. Each FP driver may also be part of the operating system kernel. The FP driver performs all generic fibre channel operations such as topology discovery (e.g., loop, point-to-point, fabric, etc.), device discovery (on various topologies), handling extended link services, handling link state changes, etc. The fabric driver 504 may also include host adapter drivers 808 for each host adapter/controller board on the host system. For example FCA drivers may be present for fibre channel adapters having fibre channel ports on the host system.

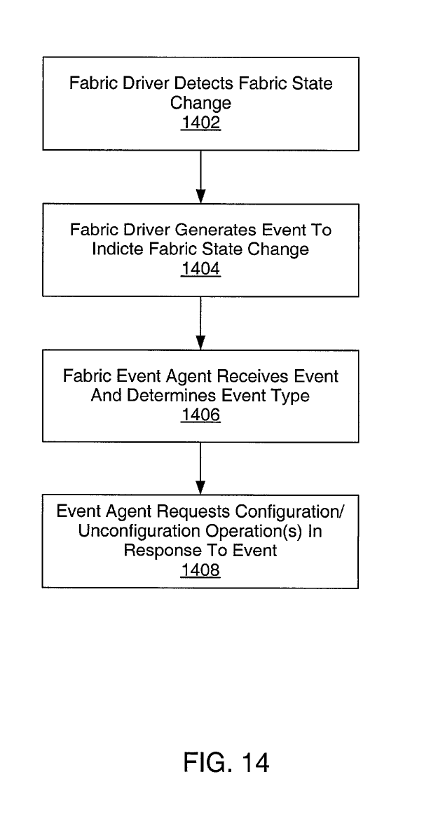

FIG. 14 is a flow chart illustrating an event driven node configuration process in response to dynamic changes in fabric connectivity. A fabric driver on a host system (e.g. fabric driver 504) may detect fabric state changes, as indicated at 1402. As described above, fabric state changes may include changes in the connectivity of a host adapter or host adapter port to the fabric and/or changes in the availability of fabric device through a particular host adapter or host adapter port. The fabric driver may generate an event to indicate the fabric state change, as indicated at 1404. A fabric event agent, registered to receive such events, may receive the event and determine the event type as indicated at 1406. The event agent may request a configuration/unconfiguration operation in response to the event, as indicated at 1408. The configuration/unconfiguration operation may depend on the event type, and the persistent repository may be accessed to be updated to reflect fabric device node changes or to determine which fabric devices are to be configured/unconfigured.

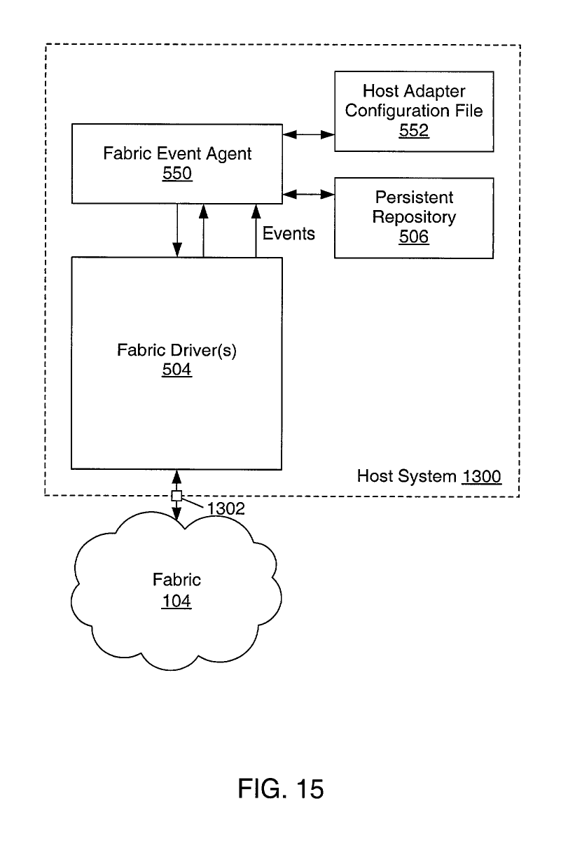

In one embodiment the fabric event agent 550 may access a host adapter configuration file to determine the action to be taken in response to a fabric state change event. FIG. 15 illustrates a system including a host adapter configuration file 552. The host adapter configuration file 552 may be stored in a manner accessible by the host system. In one embodiment, a host adapter configuration file 552 may be provided for each host adapter of the host system. In other embodiments, a single host adapter configuration file may provide information for each host adapter of the host system. The host adapter configuration file 552 may indicate the action to be taken when a fabric state change event is detected for a particular host adapter.

In one embodiment, host adapter configuration file 552 comprises one or more user-defined attributes for a host adapter. The attribute may indicate whether or not fabric devices on that particular fabric host adapter should be configured or unconfigured upon detection of a particular fabric state changed event. For example, if an event is detected indicating that a particular fabric host adapter has been disconnected from the fabric, an attribute in the host adapter configuration file 552 for that host adapter may indicate that the fabric devices configured with nodes for that particular host adapter should be unconfigured (e.g. off-lined). The host adapter configuration file 552 may also include an attribute indicating the action to be taken when a particular host adapter's connectivity is restored. For example, an attribute in the host adapter configuration file may indicate either to configure or not to configure the fabric devices on a particular fabric host adapter upon an event indicating reattachment of that host adapter. The configuration file 552 may also include attributes indicating whether or not newly connected fabric should be dynamically configured for a particular host adapter. In other embodiments, an attribute may be included in the configuration file 552 to indicate whether or not fabric devices should be unconfigured upon detection of an event indicating that the device is no longer available on the fabric. In some embodiments, attributes may indicate whether or not a particular type (e.g. storage device or hard drive) of fabric device should be configured/unconfigured upon detection of an event indicating that the particular type of device has been added/removed to/from the fabric visible through a particular host adapter or host adapter port. In one embodiment, one attribute may indicate whether or not to perform the configure/unconfigure operation and another attribute may indicate the device type.

An example host adapter configuration file format is as follows:

| | | | Configure |
|---|---|---|---|
| | | | Newly |
| | Configure | Unconfigure | Connected |
| Host Adapter Port | on Attach | on Detach | Device |
| /pci@4,2000/pci@4/SUNW,qlc@4/fp@0,0 | Yes | Yes | Yes |
| /pci@4,2000/pci@4/SUNW,qlc@5/fp@0,0 | Yes | Yes | No |
| /pci@4,4000/pci@4/SUNW,qlc@4/fp@0,0 | Yes | Yes | Yes |
| /pci@4,4000/pci@4/SUNW,qlc@5/fp@0,0 | Yes | Yes | No |

The Host Adapter Port column may identify a particular host adapter or host adapter port. The Configure on Attach column indicates whether or not fabric devices on a particular host adapter (port) should be configured when an event indicating fabric connectivity for that host adapter (port) is detected. The Unconfigure on Detach field indicates whether the devices configured on that fabric host adapter (port) should be unconfigured or not when a fabric host adapter (port) is detached. The Configure Newly Connected Device field indicates if a newly connected fabric device is to be configured or not on a particular host adapter (port). Fewer or more fields may be included in the host adapter configuration file, and the other fields may indicate other actions to be taken in response to dynamic fabric state change events. The fields or attributes in the host adapter configuration file may be set by a user, such as a system administrator. Thus allowing the user to specify the action to be taken in regard to certain fabric connectivity state changes.

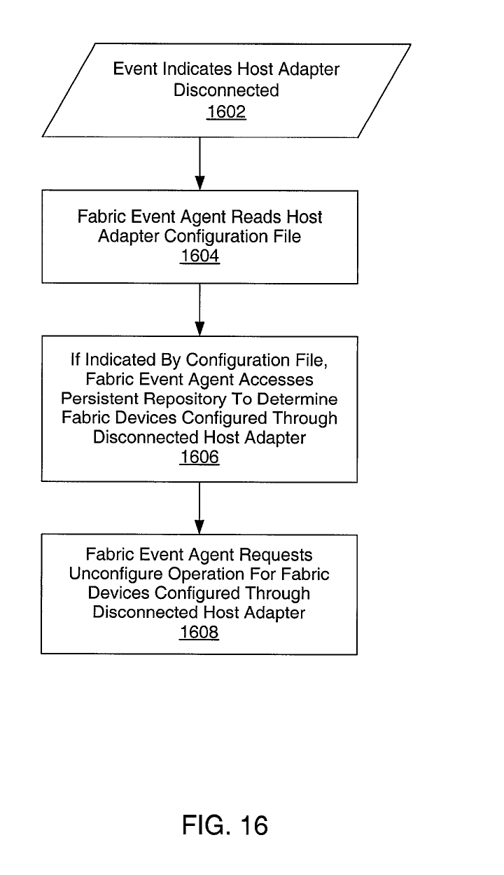

Turning now to FIG. 16, a flowchart is provided illustrating an event driven configuration process for an event in which a host adapter loses connectivity to the fabric. When a host adapter loses fabric connectivity, a corresponding event may be generated, as indicated at 1602. In response to this event, the configuration file for the host adapter may be read, as indicated at 1604, to determine the action to be taken. The host adapter configuration file may indicate whether or not fabric devices onlined through the disconnected host adapter should be unconfigured or offlined. If the host adapter configuration file indicates that the devices are to be unconfigured, an unconfiguration operation may be requested. The persistent repository may be accessed to determine which fabric devices are onlined for the disconnected host adapter or host adapter port, as indicated at 1606. An unconfiguration operation may then be requested for each of the fabric devices onlined for the disconnected host adapter, as indicated at 1608. The unconfiguration operation may involve offlining the fabric devices for the disconnected host adapter. Offlining the devices may include disabling or deleting the operating system nodes for those fabric devices. In one embodiment receiving the event (1602), reading the host adapter configuration file (1604), accessing the persistent repository (1606), and requesting the unconfiguration operation (1608) may be performed by a fabric event agent. The fabric event agent may be part of an operating system library.

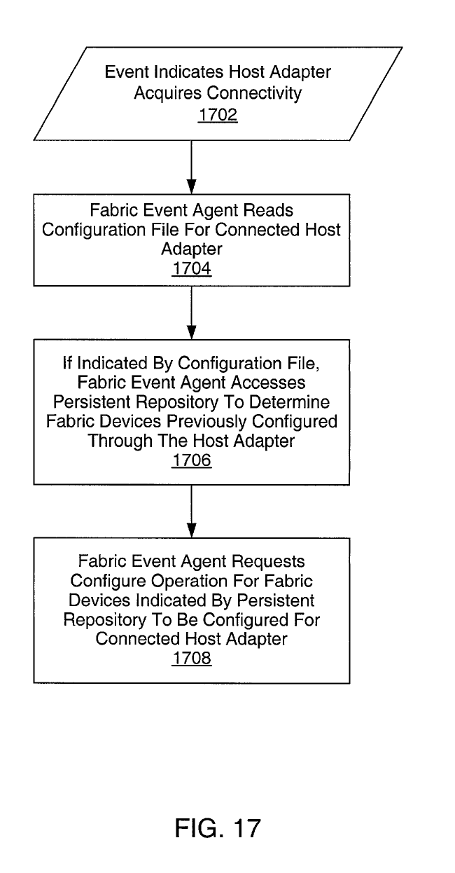

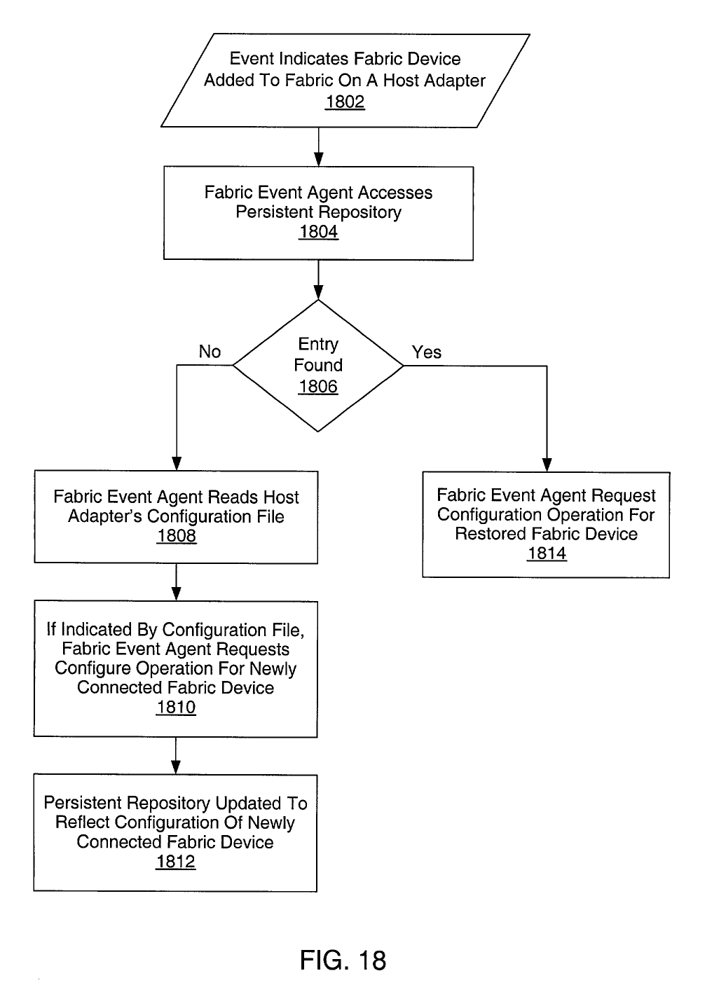

Turning now to FIG. 17 a flowchart is provided illustrating an event driven configuration process for an event in which a host adapter acquires or regains connectivity to the fabric. When a host adapter acquires fabric connectivity, a corresponding event is generated as indicated at 1702. In response to this event the configuration file for the host adapter may be read, as indicated at 1704, to determine the action to be taken. The host adapter configuration file may indicate whether or not fabric devices previously onlined through the reconnected host adapter should be configured (e.g. onlined). If the host adapter configuration file indicates that the devices are to be configured, a configuration operation may be requested. The persistent repository may be accessed to determine which fabric devices were previously onlined for the connected host adapter, as indicated at 1706. A configuration operation may then be requested for each of the fabric devices previously onlined for the disconnected host adapter, as indicated at 1708. In one embodiment, a verification operation may first be performed for each previously onlined device to verify that the device is still available on the fabric. To verify device availability, a fabric event agent may request a verification operation from a fabric driver. The fabric driver may access the fabric name server to obtain the fabric device list to verify that the device is still available. The configuration operation may involve onlining the fabric devices for the connected host adapter. Onlining the devices may include creating operating system nodes for those fabric devices. In one embodiment receiving the event (1702), reading the host adapter configuration file (1704), accessing the persistent repository (1706), and requesting the unconfiguration operation (1708) may be performed by a fabric event agent. The fabric event agent may be part of an operating system library.

If the no fabric devices were previously online for the connected host adapter port, or if the persistent repository contains no entries for the connected host adapter port, an initial configuration process may be initiated. The initial configuration process may be an on-demand node configuration process such as described in conjunction with FIGS. 7-10 above. For example, a list of fabric devices for the connected host adapter port may be passed to an administration application and a user may be prompted to select a subset of devices to be onlined.

FIG. 18 illustrates a flowchart for an event driven configuration in regard to a fabric state change of the connection of a new fabric device or restoration of a previously connected fabric device. In some embodiments, a host system may have a policy of onlining all newly connected fabric devices for one or more host adapter ports. In other embodiments such a policy may be in regard to only certain types of newly connected fabric devices, such as storage devices. The addition of a newly connected or restored fabric device may be detected by a fabric driver for one or more host adapter ports on a host system. The fabric driver may generate an event indicating the addition of a device to the fabric, as indicated at 1802. In response to the event, the persistent repository may be accessed to determine if an entry already exists in the persistent repository for the added fabric device, as indicated at 1804. An entry may already exists, for example, if a previously available fabric device had been removed from the fabric and then restored. If an entry already exists, indicating that the added device should be configured, then a configuration operation may be requested, as indicated at 1806 and 1814.

If an entry does not exist in the persistent repository for the added fabric device, the host adapter configuration file may be accessed to determine the action to be taken, as indicated at 1806 and 1808. The host adapter configuration file may indicate whether or not the newly connected fabric device should be onlined for the host adapter port corresponding to the event. If indicated by the configuration file, a configuration operation may be requested to online the newly connected fabric device, as indicated at 1810. The persistent repository may be updated to indicate that the newly connected fabric device is online for the host adapter port, as indicated at 1812. In some embodiments, receiving the event (1802), accessing the persistent repository (1804) accessing the host adapter configuration file (1808), requesting the configuration operation (1810, 1814), and/or updating the persistent repository (1812), may be performed by a fabric event agent. In some embodiments the configuration operation includes a node creation process as described above. The newly connected fabric device my be verified before performing node creation. The fabric device may be verified by requesting a list of fabric devices from the fabric name server as described above.

A similar process to that described for FIG. 18 may be performed for events indicating the disconnection of a fabric device. Other fabric state change events may be handled as well.

In one embodiment the fabric state change event may be delivered by the fabric driver through an event abstract data structure, such as:

event id

event type: attach/detach/fabricchange

event change type: insert/remove/null

event port: the host adapter port which has the change occur, or global

The event id provides a unique identification for each event. The event type indicates the type of event delivered, e.g. the type of event detected by the fabric driver. For example, an event type of “attach” may indicate that a host port adapter driver or instance of a driver has just been dynamically attached for a particular host adapter port, indicating that the host adapter port is now connected to the fabric. Similarly an event type of “detach” may indicate that a host port adapter driver or instance of a driver is no longer attached, indicating that host adapter port is no longer connected to the fabric. The event type “fabric change” may indicate that the fabric driver has received a configuration change notice from the fabric. The event data structure may include an event change type field to indicate the type of fabric change. The event change type field of the event data structure may be valid for only the fabric change type of event. The event change type field may indicate a type of “added” when a fabric device has been added or “removed” when a fabric device has been removed. In one embodiment, the event change type field may indicate a null value. If the value is null, the fabric event agent may determine the change type by requesting a current fabric device list (e.g. from the fabric driver/fabric name server). The fabric event agent may compare the current fabric device list to a previous device list (or to the persistent repository) to determine if a fabric device has been added or removed from the fabric.

The event port field of the event data structure indicates for which fabric host adapter port the state change has occurred. In one embodiment an event may be a global event, in which case the fabric event agent may perform the dynamic reconfiguration process described herein for each host adapter port.

Various modifications and changes may be made as would be obvious to a person skilled in the art having the benefit of this disclosure. Note also that the flow charts described herein do not necessary require a temporal order. It is intended that the following claims be interpreted to embrace all such modifications and changes and, accordingly, the specifications and drawings are to be regarded in an illustrative rather than a restrictive sense.

Various embodiments may further include receiving, sending or storing instructions and/or data implemented in accordance with the foregoing description upon a computer readable medium. Generally speaking, a computer readable medium may include storage media or memory media such as magnetic or optical media, e.g., disk or CD-ROM, volatile or non-volatile media such as RAM (e.g. SDRAM, DDR SDRAM, RDRAM, SRAM, etc.), ROM, etc. as well as transmission media or signals such as electrical, electromagnetic, or digital signals, conveyed via a communication medium such as network and/or a wireless link.

What is claimed is:

1. A method for handling fabric state changes, comprising:
receiving an event indicating a fabric state change for one or more host adapter ports; and
dynamically changing the host system's fabric device configuration in response to said receiving an event;
wherein said dynamically changing comprises bringing online or taking offline one or more fabric devices for the one or more host adapter ports for the host system.

2. The method as recited in claim 1, further comprising determining an event type for said event.

3. The method as recited in claim 2, wherein if the event type indicates that one of the fabric host adapter ports has lost connectivity to the fabric, said dynamically changing comprises taking offline one or more fabric devices configured through the host adapter port that lost connectivity to the fabric.

4. The method as recited in claim 3, wherein said taking offline one or more fabric devices configured through the host adapter port that lost connectivity to the fabric comprises:
reading a persistent repository that indicates which fabric devices are currently online for the host adapter port that lost connectivity to the fabric; and
taking offline the fabric devices indicated by the persistent repository for the host adapter port that lost connectivity to the fabric.

5. The method as recited in claim 3, wherein said taking offline comprises disabling an operating system node for each of the one or more fabric devices being taken offline, wherein each operating system node provides a communication mechanism to a corresponding fabric device.

6. The method as recited in claim 2, wherein if the event type indicates that one of the fabric host adapter ports has lost connectivity to the fabric, said dynamically changing comprises:
accessing a configuration file for the host adapter port that lost connectivity to the fabric to determine if fabric devices for that host adapter port are to be unconfigured if that host adapter port loses connectivity to the fabric; and
if the configuration file indicates that fabric devices are to be unconfigured upon lose of connectivity to the fabric, taking offline one or more fabric devices configured through the host adapter port that lost connectivity to the fabric.

7. The method as recited in claim 6, wherein taking offline one or more fabric devices configured through the host adapter port that lost connectivity to the fabric comprises:
reading a persistent repository that indicates which fabric devices are currently online for the host adapter port that lost connectivity to the fabric; and
taking offline the fabric devices indicated by the persistent repository for the host adapter port that lost connectivity to the fabric.

8. The method as recited in claim 6, wherein said taking offline comprises disabling an operating system node for each of the one or more fabric devices being taken offline, wherein each operating system node provides a communication mechanism to a corresponding fabric device.

9. The method as recited in claim 6, further comprising, prior to said receiving an event:
a host adapter driver for one of the one or more host adapter ports becoming inactive or detached; and
generating the event indicating that one of the one or more host adapter ports has lost connectivity to the fabric.

10. The method as recited in claim 6, wherein said accessing a configuration file for the host adapter port that lost connectivity to the fabric comprises reading a user-defined attribute in the configuration file, wherein the user-define attribute indicates whether or not fabric devices for that host adapter port are to be unconfigured if that host adapter port loses connectivity to the fabric

11. The method as recited in claim 2, wherein if the event type indicates that one of the fabric host adapter ports has acquired connectivity to the fabric, said dynamically changing comprises bringing online one or more fabric devices for the host adapter port that has acquired connectivity to the fabric.

12. The method as recited in claim 11, wherein said bringing online one or more fabric devices for the host adapter port that has acquired connectivity to the fabric comprises:
reading a persistent repository that indicates which fabric devices were previously online for the host adapter port that has acquired connectivity to the fabric; and
bringing online the fabric devices indicated by the persistent repository for the host adapter port that has acquired connectivity to the fabric.

13. The method as recited in claim 11, wherein said bringing online comprises creating an operating system node for each of the one or more fabric devices being brought online, wherein each operating system node provides a communication mechanism to a corresponding fabric device.

14. The method as recited in claim 2, wherein if the event type indicates that one of the fabric host adapter ports has acquired connectivity to the fabric, said dynamically changing comprises:
accessing a configuration file for the host adapter port that has acquired connectivity to the fabric to determine if fabric devices for that host adapter port are to be configured if that host adapter port acquires connectivity to the fabric; and
if the configuration file indicates that fabric devices are to be configured upon that host adapter port's connectivity to the fabric, bringing online one or more fabric devices for that host adapter port that has acquired connectivity to the fabric.

15. The method as recited in claim 14, wherein bringing online one or more fabric devices configured through the host adapter port that has acquired connectivity to the fabric comprises:
reading a persistent repository that indicates which fabric devices were previously online for the host adapter port that has acquired connectivity to the fabric; and
bringing online the fabric devices indicated by the persistent repository for the host adapter port that has acquired connectivity to the fabric.

16. The method as recited in claim 14, wherein said bringing online comprises creating an operating system node for each of the one or more fabric devices being brought online, wherein each operating system node provides a communication mechanism to a corresponding fabric device.

17. The method as recited in claim 14, further comprising, prior to said receiving an event:
a host adapter driver for one of the one or more host adapter ports becoming active or attached; and
generating the event indicating that one of the one or more host adapter ports has acquired connectivity to the fabric.

18. The method as recited in claim 14, wherein said accessing a configuration file for the host adapter port that has acquired connectivity to the fabric comprises reading a user-defined attribute in the configuration file, wherein the user-define attribute indicates whether or not fabric devices for that host adapter port are to be configured if that host adapter port acquires connectivity to the fabric.

19. The method as recited in claim 2, wherein if the event type indicates that a new fabric device has been connected to the fabric, said dynamically changing comprises bringing online the new fabric device for one of the one or more host adapter ports.

20. The method as recited in claim 19, wherein said bringing online comprises creating an operating system node for the new fabric device being brought online, wherein the operating system node provides a communication mechanism to the new fabric device.

21. The method as recited in claim 19, wherein said bringing online the new fabric device comprises updating a persistent repository to indicate that the new fabric device is online for the host adapter port.

22. The method as recited in claim 2, wherein if the event type indicates that a new fabric device has been connected to the fabric, said dynamically changing comprises:
accessing a configuration file for one of the one or more host adapter ports to determine if newly connected fabric devices for that host adapter port are to be dynamically configured; and
if the configuration file indicates newly connected fabric devices are to be dynamically configured, bringing online the new fabric device for that host adapter port.

23. The method as recited in claim 22, wherein said bringing online comprises creating an operating system node for the new fabric device being brought online, wherein the operating system node provides a communication mechanism to the new fabric device.

24. The method as recited in claim 22, wherein said bringing online the new fabric device comprises updating a persistent repository to indicate that the new fabric device is online for the host adapter port.

25. The method as recited in claim 22, further comprising, prior to said receiving an event:
connecting the fabric device to the fabric; and
a fabric driver generating the event indicating that the new fabric device has been connected to the fabric.

26. The method as recited in claim 22, wherein said accessing a configuration file comprises reading a user-defined attribute in the configuration file, wherein the user-define attribute indicates whether or not newly connected fabric devices for that host adapter port are to be dynamically configured upon detection.

27. The method as recited in claim 1, wherein the one or more host adapter ports comprise Fibre Channel host adapter ports.

28. The method as recited in claim 1, wherein the fabric comprises a Fibre Channel switched fabric comprising a plurality of Fibre Channel switches.

29. The method as recited in claim 1, wherein the fabric is part of a storage area network (SAN), and wherein the fabric devices comprise storage devices.

30. The method as recited in claim 1, wherein said dynamically changing comprises verifying the one or more fabric devices before bringing the one or more fabric devices online, wherein said verifying comprises accessing a fabric name server to determine if the one or more fabric devices are currently connected to the fabric.

31. A host system, comprising:
one or more host adapter ports for coupling to a fabric;
a fabric event agent configured to:
receive an event indicating a fabric state change for one or more of the host adapter ports; and
dynamically change the host system's fabric device configuration in response to said receiving an event;
wherein the fabric event agent is configured to dynamically change the host system's fabric device configuration by bringing online or taking offline one or more fabric devices for the one or more host adapter ports for the host system.

32. The host system as recited in claim 31, wherein the fabric event agent is further configured to determine event type for said event.

33. The host system as recited in claim 32, wherein if the event type indicates that one of the fabric host adapter ports has lost connectivity to the fabric, the fabric event agent is further configured to dynamically change the host system's fabric device configuration by taking offline one or more fabric devices configured through the host adapter port that lost connectivity to the fabric.

34. The host system as recited in claim 33, wherein said taking offline one or more fabric devices configured through the host adapter port that lost connectivity to the fabric comprises:
reading a persistent repository that indicates which fabric devices are currently online for the host adapter port that lost connectivity to the fabric; and
taking offline the fabric devices indicated by the persistent repository for the host adapter port that lost connectivity to the fabric.

35. The host system as recited in claim 33, wherein said taking offline comprises disabling an operating system node for each of the one or more fabric devices being taken offline, wherein each operating system node provides a communication mechanism to a corresponding fabric device.

36. The host system as recited in claim 32, wherein if the event type indicates that one of the fabric host adapter ports has lost connectivity to the fabric, the fabric event agent is further configured to dynamically change the host system's fabric device configuration by:
accessing a configuration file for the host adapter port that lost connectivity to the fabric to determine if fabric devices for that host adapter port are to be unconfigured if that host adapter port loses connectivity to the fabric; and
if the configuration file indicates that fabric devices are to be unconfigured upon lose of connectivity to the fabric, taking offline one or more fabric devices configured through the host adapter port that lost connectivity to the fabric.

37. The host system as recited in claim 36, wherein taking offline one or more fabric devices configured through the host adapter port that lost connectivity to the fabric comprises:
reading a persistent repository that indicates which fabric devices are currently online for the host adapter port that lost connectivity to the fabric; and
taking offline the fabric devices indicated by the persistent repository for the host adapter port that lost connectivity to the fabric.

38. The host system as recited in claim 36, wherein said taking offline comprises disabling an operating system node for each of the one or more fabric devices being taken offline, wherein each operating system node provides a communication mechanism to a corresponding fabric device.

39. The host system as recited in claim 36, further comprising:
a host adapter driver for one of the one or more host adapter ports; and
a fabric driver configured to generate the event indicating that one of the one or more host adapter ports has lost connectivity to the fabric.

40. The host system as recited in claim 36, wherein said accessing a configuration file for the host adapter port that lost connectivity to the fabric comprises reading a user-defined attribute in the configuration file, wherein the user-define attribute indicates whether or not fabric devices for that host adapter port are to be unconfigured if that host adapter port loses connectivity to the fabric

41. The host system as recited in claim 32, wherein if the event type indicates that one of the fabric host adapter ports has acquired connectivity to the fabric, the fabric event agent is further configured to dynamically change the host system's fabric device configuration by bringing online one or more fabric devices for the host adapter port that has acquired connectivity to the fabric.

42. The host system as recited in claim 41, wherein said bringing online one or more fabric devices for the host adapter port that has acquired connectivity to the fabric comprises:
reading a persistent repository that indicates which fabric devices were previously online for the host adapter port that has acquired connectivity to the fabric; and
bringing online the fabric devices indicated by the persistent repository for the host adapter port that has acquired connectivity to the fabric.

43. The host system as recited in claim 41, wherein said bringing online comprises creating an operating system node for each of the one or more fabric devices being brought online, wherein each operating system node provides a communication mechanism to a corresponding fabric device.

44. The host system as recited in claim 32, wherein if the event type indicates that one of the fabric host adapter ports has acquired connectivity to the fabric, the fabric event agent is further configured to dynamically change the host system's fabric device configuration by:
accessing a configuration file for the host adapter port that has acquired connectivity to the fabric to determine if fabric devices for that host adapter port are to be configured if that host adapter port acquires connectivity to the fabric; and
if the configuration file indicates that fabric devices are to be configured upon that host adapter port's connectivity to the fabric, bringing online one or more fabric devices for that host adapter port that has acquired connectivity to the fabric.

45. The host system as recited in claim 44, wherein bringing online one or more fabric devices configured through the host adapter port that has acquired connectivity to the fabric comprises:
reading a persistent repository that indicates which fabric devices were previously online for the host adapter port that has acquired connectivity to the fabric; and
bringing online the fabric devices indicated by the persistent repository for the host adapter port that has acquired connectivity to the fabric.

46. The host system as recited in claim 44, wherein said bringing online comprises creating an operating system node for each of the one or more fabric devices being brought online, wherein each operating system node provides a communication mechanism to a corresponding fabric device.

47. The host system as recited in claim 44, further comprising:
a host adapter driver for one of the one or more host adapter ports becoming active or attached prior to said receiving an event; and
a fabric driver generating the event indicating that one of the one or more host adapter ports has acquired connectivity to the fabric.

48. The host system as recited in claim 44, wherein said accessing a configuration file for the host adapter port that has acquired connectivity to the fabric comprises reading a user-defined attribute in the configuration file, wherein the user-define attribute indicates whether or not fabric devices for that host adapter port are to be configured if that host adapter port acquires connectivity to the fabric.

49. The host system as recited in claim 32, wherein if the event type indicates that a new fabric device has been connected to the fabric, the fabric event agent is further configured to dynamically change the host system's fabric device configuration by bringing online the new fabric device for one of the one or more host adapter ports.

50. The host system as recited in claim 49, wherein said bringing online comprises creating an operating system node for the new fabric device being brought online, wherein the operating system node provides a communication mechanism to the new fabric device.

51. The host system as recited in claim 49, wherein said bringing online the new fabric device comprises updating a persistent repository to indicate that the new fabric device is online for the host adapter port.

52. The host system as recited in claim 32, wherein if the event type indicates that a new fabric device has been connected to the fabric, the fabric event agent is further configured to dynamically change the host system's fabric device configuration by:
accessing a configuration file for one of the one or more host adapter ports to determine if newly connected fabric devices for that host adapter port are to be dynamically configured; and
if the configuration file indicates newly connected fabric devices are to be dynamically configured, bringing online the new fabric device for that host adapter port.

53. The host system as recited in claim 52, wherein said bringing online comprises creating an operating system node for the new fabric device being brought online, wherein the operating system node provides a communication mechanism to the new fabric device.

54. The host system as recited in claim 52, wherein said bringing online the new fabric device comprises updating a persistent repository to indicate that the new fabric device is online for the host adapter port.

55. The host system as recited in claim 52, further comprising:
a fabric driver generating the event indicating that the new fabric device has been connected to the fabric.

56. The host system as recited in claim 52, wherein said accessing a configuration file comprises reading a user-defined attribute in the configuration file, wherein the user-define attribute indicates whether or not newly connected fabric devices for that host adapter port are to be dynamically configured upon detection.

57. The host system as recited in claim 31, wherein the one or more host adapter ports comprise Fibre Channel host adapter ports.

58. The host system as recited in claim 31, wherein the fabric comprises a Fibre Channel switched fabric comprising a plurality of Fibre Channel switches.

59. The host system as recited in claim 31, wherein the fabric is part of a storage area network (SAN), and wherein the fabric devices comprise storage devices.

60. The host system as recited in claim 31, wherein the fabric event agent is further configured to dynamically change the host system's fabric device configuration by verifying the one or more fabric devices before bringing the one or more fabric devices online, wherein said verifying comprises accessing a fabric name server to determine if the one or more fabric devices are currently connected to the fabric.

61. A computer readable medium having stored thereon data representing program instructions, wherein the program instructions are executable by one or more processors to implement:
receiving an event indicating a fabric state change for one or more host adapter ports; and
dynamically changing the host system's fabric device configuration in response to said receiving an event;
wherein said dynamically changing comprises bringing online or taking offline one or more fabric devices for the one or more host adapter ports for the host system.

62. The computer readable medium as recited in claim 61, wherein the program instructions are further executable to implement determining an event type for said event.

63. The computer readable medium as recited in claim 62, wherein if the event type indicates that one of the fabric host adapter ports has lost connectivity to the fabric, said dynamically changing comprises taking offline one or more fabric devices configured through the host adapter port that lost connectivity to the fabric.

64. The computer readable medium as recited in claim 63, wherein said taking offline one or more fabric devices configured through the host adapter port that lost connectivity to the fabric comprises:
reading a persistent repository that indicates which fabric devices are currently online for the host adapter port that lost connectivity to the fabric; and
taking offline the fabric devices indicated by the persistent repository for the host adapter port that lost connectivity to the fabric.

65. The computer readable medium as recited in claim 63, wherein said taking offline comprises disabling an operating system node for each of the one or more fabric devices being taken offline, wherein each operating system node provides a communication mechanism to a corresponding fabric device.

66. The computer readable medium as recited in claim 62, wherein if the event type indicates that one of the fabric host adapter ports has lost connectivity to the fabric, said dynamically changing comprises:
accessing a configuration file for the host adapter port that lost connectivity to the fabric to determine if fabric devices for that host adapter port are to be unconfigured if that host adapter port loses connectivity to the fabric; and
if the configuration file indicates that fabric devices are to be unconfigured upon lose of connectivity to the fabric, taking offline one or more fabric devices configured through the host adapter port that lost connectivity to the fabric.

67. The computer readable medium as recited in claim 66, wherein taking offline one or more fabric devices configured through the host adapter port that lost connectivity to the fabric comprises:
reading a persistent repository that indicates which fabric devices are currently online for the host adapter port that lost connectivity to the fabric; and
taking offline the fabric devices indicated by the persistent repository for the host adapter port that lost connectivity to the fabric.

68. The computer readable medium as recited in claim 66, wherein said taking offline comprises disabling an operating system node for each of the one or more fabric devices being taken offline, wherein each operating system node provides a communication mechanism to a corresponding fabric device.

69. The computer readable medium as recited in claim 66, wherein the program instructions are further executable to implement, prior to said receiving an event:
a host adapter driver for one of the one or more host adapter ports becoming inactive or detached; and
generating the event indicating that one of the one or more host adapter ports has lost connectivity to the fabric.

70. The computer readable medium as recited in claim 66, wherein said accessing a configuration file for the host adapter port that lost connectivity to the fabric comprises reading a user-defined attribute in the configuration file, wherein the user-define attribute indicates whether or not fabric devices for that host adapter port are to be unconfigured if that host adapter port loses connectivity to the fabric

71. The computer readable medium as recited in claim 62, wherein if the event type indicates that one of the fabric host adapter ports has acquired connectivity to the fabric, said dynamically changing comprises bringing online one or more fabric devices for the host adapter port that has acquired connectivity to the fabric.

72. The computer readable medium as recited in claim 71, wherein said bringing online one or more fabric devices for the host adapter port that has acquired connectivity to the fabric comprises:
reading a persistent repository that indicates which fabric devices were previously online for the host adapter port that has acquired connectivity to the fabric; and
bringing online the fabric devices indicated by the persistent repository for the host adapter port that has acquired connectivity to the fabric.

73. The computer readable medium as recited in claim 71, wherein said bringing online comprises creating an operating system node for each of the one or more fabric devices being brought online, wherein each operating system node provides a communication mechanism to a corresponding fabric device.

74. The computer readable medium as recited in claim 62, wherein if the event type indicates that one of the fabric host adapter ports has acquired connectivity to the fabric, said dynamically changing comprises:
accessing a configuration file for the host adapter port that has acquired connectivity to the fabric to determine if fabric devices for that host adapter port are to be configured if that host adapter port acquires connectivity to the fabric; and
if the configuration file indicates that fabric devices are to be configured upon that host adapter port's connectivity to the fabric, bringing online one or more fabric devices for that host adapter port that has acquired connectivity to the fabric.

75. The computer readable medium as recited in claim 74, wherein bringing online one or more fabric devices configured through the host adapter port that has acquired connectivity to the fabric comprises:
reading a persistent repository that indicates which fabric devices were previously online for the host adapter port that has acquired connectivity to the fabric; and
bringing online the fabric devices indicated by the persistent repository for the host adapter port that has acquired connectivity to the fabric.

76. The computer readable medium as recited in claim 74, wherein said bringing online comprises creating an operating system node for each of the one or more fabric devices being brought online, wherein each operating system node provides a communication mechanism to a corresponding fabric device.

77. The computer readable medium as recited in claim 74, wherein the program instructions are further executable to implement, prior to said receiving an event:
a host adapter driver for one of the one or more host adapter ports becoming active or attached; and
generating the event indicating that one of the one or more host adapter ports has acquired connectivity to the fabric.

78. The computer readable medium as recited in claim 74, wherein said accessing a configuration file for the host adapter port that has acquired connectivity to the fabric comprises reading a user-defined attribute in the configuration file, wherein the user-define attribute indicates whether or not fabric devices for that host adapter port are to be configured if that host adapter port acquires connectivity to the fabric.

79. The computer readable medium as recited in claim 62, wherein if the event type indicates that a new fabric device has been connected to the fabric, said dynamically changing comprises bringing online the new fabric device for one of the one or more host adapter ports.

80. The computer readable medium as recited in claim 79, wherein said bringing online comprises creating an operating system node for the new fabric device being brought online, wherein the operating system node provides a communication mechanism to the new fabric device.

81. The computer readable medium as recited in claim 79, wherein said bringing online the new fabric device comprises updating a persistent repository to indicate that the new fabric device is online for the host adapter port.

82. The computer readable medium as recited in claim 62, wherein if the event type indicates that a new fabric device has been connected to the fabric, said dynamically changing comprises:
accessing a configuration file for one of the one or more host adapter ports to determine if newly connected fabric devices for that host adapter port are to be dynamically configured; and
if the configuration file indicates newly connected fabric devices are to be dynamically configured, bringing online the new fabric device for that host adapter port.

83. The computer readable medium as recited in claim 82, wherein said bringing online comprises creating an operating system node for the new fabric device being brought online, wherein the operating system node provides a communication mechanism to the new fabric device.

84. The computer readable medium as recited in claim 82, wherein said bringing online the new fabric device comprises updating a persistent repository to indicate that the new fabric device is online for the host adapter port.

85. The computer readable medium as recited in claim 82, wherein the program instructions are further executable to implement, prior to said receiving an event:
connecting the fabric device to the fabric; and
a fabric driver generating the event indicating that the new fabric device has been connected to the fabric.

86. The computer readable medium as recited in claim 82, wherein said accessing a configuration file comprises reading a user-defined attribute in the configuration file, wherein the user-define attribute indicates whether or not newly connected fabric devices for that host adapter port are to be dynamically configured upon detection.

87. The computer readable medium as recited in claim 61, wherein the one or more host adapter ports comprise Fibre Channel host adapter ports.

88. The computer readable medium as recited in claim 61, wherein the fabric comprises a Fibre Channel switched fabric comprising a plurality of Fibre Channel switches.

89. The computer readable medium as recited in claim 61, wherein the fabric is part of a storage area network (SAN), and wherein the fabric devices comprise storage devices.

90. The computer readable medium as recited in claim 61, wherein said dynamically changing comprises verifying the one or more fabric devices before bringing the one or more fabric devices online, wherein said verifying comprises accessing a fabric name server to determine if the one or more fabric devices are currently connected to the fabric.
